(19) United States
(12) Patent Application Publication
(10) Pub. No.: US 2024/0059395 A1
(43) Pub. Date: Feb. 22, 2024

(54) Turbulence Dampening Mechanism

(71) Applicant: Mark Ogram, Tucson, AR (US)

(72) Inventor: Mark Ogram, Tucson, AR (US)

(21) Appl. No.: 17/803,547

(22) Filed: Aug. 17, 2022

(51) Int. Cl. B64C 9/22

(52) U.S. Cl. CPC B64C 9/22; B64D 2045/0085

(57) ABSTRACT

A turbulence dampening system for an aircraft. Using a motion sensor positioned in an airfoil or fuselage of the aircraft, a motion sensor generates signals indicative of relative motion of an airfoil. Lifting action of the airfoil is dampened based upon the signals from the motion sensor. Dampening of the lifting action is through the use of disruption of the air flowing over the airflow.

### BACKGROUND OF THE INVENTION

This invention relates generally to airplanes and more particularly to stabilizing mechanism for turbulence.

In fluid dynamics, turbulence is characterized by chaotic changes in pressure and flow velocity and is commonly observed in billowing storm clouds but also occurs in what is termed clear air turbulence. Clear air turbulence occurs at high altitudes and is often encountered by commercial and military aircraft. At lower altitudes, often turbulence is created by rising air from mountains or the terrain configurations or thermals.

Whether at high altitudes or low altitudes, turbulence creates a “rocky” ride disrupting the passengers, scientific instruments, and armaments. If turbulence could be either eliminated or at least dampened, then these problems would be diminished or eliminated completely.

A variety of attempts have been made to address the turbulence problem, including, but not limited to those described in U.S. Pat. No. 7,971,850, issued Jul. 5, 2011, to Heim et al. and entitled “Electroactive Polymer Devices for Controlling Fluid Flow”; U.S. Pat. No. 10,099,793, issued Oct. 16, 2018, to Ulman et al. and entitled “Distributed Electric Ducted Fan Wing”; and, U.S. Pat. No. 11,174,002, issued Nov. 16, 2021, to Kota et al. and entitled “Edge Morphing Arrangement for an Airfoil”, all of which are incorporated hereinto by reference.

It is clear there is a need for automatically dampening turbulence for an airplane in rough weather.

### SUMMARY OF THE INVENTION

The invention is a turbulence dampening system for an aircraft. Using a motion sensor positioned in an airfoil or fuselage of the aircraft, the motion sensor generates signals indicative of relative motion of the airfoil. Lifting action of the airfoil is dampened based upon the signals from the motion sensor to “balance” the overall lift experienced by the airfoil. Dampening of the lifting action is via disruption of the air flowing over the airflow.

An aircraft typically has a fuselage with two airfoils attached thereto. It is the wing that provides the lifting action by causing a difference in the speed of air over the airfoil compared to that under the airfoil. A higher velocity airflow exerts less pressure, hence the pressure on the top of the airfoil is less, allowing the pressure below the airfoil to push upwards on the airfoil.

Airfoils are well known in the art and include, but are not limited to: U.S. Pat. No. 11,396,368, issued Jul. 26, 2022, to Petscher et al., and entitled “Airplane Wing”; and, U.S. Pat. No. 4,365,774, issued Dec. 28, 1982, to Coronel and entitled “Convertible Delta Wing Aircraft”; both of which are incorporated hereinto by reference.

As noted above, turbulence, whatever the cause, causes the aircraft to experience bumpy conditions. In the present invention, a motion sensor is positioned within the aircraft. The motion detector identifies when the turbulence is attempting to raise the airfoil by exerting additional lift to airfoil. When this occurs, the motion sensor generating signals to cause the airfoil dampening mechanism to engage. The airfoil dampening mechanism decreases the natural lift of the airflow on the airfoil to compensate/balance for the turbulence.

This dampening or lowering of the lifting property of the airflow takes on various configurations which are intended to reduce the lifting area of the wing by re-directing the air flowing over the airfoil.

In some embodiments, the turbulence dampening system of this invention is ideally on both airfoils of the aircraft allowing the motion sensor to address whichever airfoil is being affected most by the turbulence. In this way, if the motion sensor is positioned on the starboard airfoil, the motion sensor is able to control the dampening mechanism on the port airfoil as well as the starboard airfoil.

In the preferred embodiment, the motion sensor is located within the fuselage.

Wherever the motion sensor is located, it's purpose is to identify rotational motion of the first and second airfoil around an axis formed by the fuselage. In some embodiments, the motion sensor also identifies an upward and downward angle of the fuselage (rising or falling). In this situation, corrective action by disabling the dampening mechanisms when the rise/fall exceeds a predefined angle allows the pilot can properly control the aircraft without being hampered by the dampening mechanisms.

A wide variety of dampening mechanisms are contemplated in this invention. In a first one, a central support extends through the skin of the airfoil. The central support is controlled by a solenoid or motor. Attached to the central support is at least one extendable wing. These extendable wings disrupt the flow of air over the airfoil thereby, reducing the “lifting surface” of the airfoil.

In another embodiment of the dampening mechanism, a vane swivelly extends from the central support. A solenoid or motor within the airfoil is connected the support to direct the vane. The solenoid/motor selectively rotates the vane based on signals from the motion sensor to reduce the “lifting surface” of the airfoil.

In yet another embodiment, a panel lies substantially flush with the upper surface of the airfoil when the panel is in an inactive position. When activated, the rearward side of the panel is raised to change the airflow over the airfoil. Again, a solenoid or motor is used to move the rearward portion of the panel.

Also within this invention, a variety of motion sensors are contemplated. In one embodiment, a “plump bob” hangs pointing towards the ground due to its weighted tip. As the plane moves thereunder, this movement is detected and used to establish motion signals.

The use of plump-bobs or plummets are well known in the art and include, but are not limited to, those described in: U.S. Pat. No. 6,948,253, issued Sep. 27, 2005, to Lin and entitled “Plumb-bob”; U.S. Pat. No. 5,195,248, issued Mar. 23, 1993, to Juhasz and entitled “Plumb-bob”; and U.S. Pat. No. 11,320,264, issued May 3, 2022, to Melton and entitle “Laser Plumb Bob and Level Aid”; all of which are incorporated hereinto by reference.

Another motion sensor of this invention uses a curved clear housing having a cavity therein. Opaque liquid or a reflective liquid is partially fills the housing forming a “leveling” bubble therein. A light source is focused on a first side of the curved clear housing, and, at least two light receptors positioned on the second side of the curved clear housing to sense the movement of the bubble within the housing. This movement identifies what rotation is being experienced.

In this embodiment, one class of motion sensors uses a tubular shaped housing. This provides a left/right sensing. In another class of this embodiment, the curved clear housing is circular and concave in shape; this class provides motion sensing in 360 degrees.

In still another embodiment of the motion sensor, the motion sensor utilizes a gyroscope aligned along an axis of the airfoil to sense movement.

Those of ordinary skill in the art readily recognize the use of gyroscopes which include, but is not limited to, those described in: U.S. Pat. No. 5,134,394, issued Jul. 28, 1992, to Beadle and entitled “Light Aircraft Navigation Apparatus”; U.S. Pat. No. 6,161,062, issued Dec. 12, 2000, to Sicre, et al. and entitled “Aircraft Piloting Aid System Using a Head-up Display”; and, U.S. Pat. No. 8,305,238, issued Nov. 6, 202, to Wegner, et al. and entitled “Man-machine Interface for Pilot Assistance”; all of which are incorporated hereinto by reference.

The invention, together with various embodiments thereof, will be explained in detail by the accompanying drawings and the following descriptions thereof.

### DRAWINGS IN BRIEF

FIG. 1 illustrates the balancing nature of the invention.

FIGS. 2A and 2B illustrate one explanation for the effectiveness of the invention.

FIGS. 3A and 3B illustrate the use of a vane for the airfoil dampening mechanism.

FIGS. 4A and 4B illustrate the use of wings for the airfoil dampening mechanism.

FIGS. 5A and 5B illustrate the use of a panel for the airfoil dampening mechanism.

FIGS. 6A and 6B illustrate the use of a plumb bob arrangement for the motion sensor.

FIGS. 7a and 7B illustrates one embodiment of the use of leveling bubble arrangement for the motion sensor.

FIGS. 8A and 8B illustrates one embodiment of the use of a mercury switch arrangement for the motion sensor.

FIGS. 9A, 9B, and 9C illustrate the use of a disc arrangement for the motion sensor.

FIG. 10 graphically illustrates the orientation consideration for the gyroscope motion sensor in an airplane.

FIG. 11 illustrates the motor/solenoid for the dampening mechanisms.

### DRAWINGS IN DETAIL

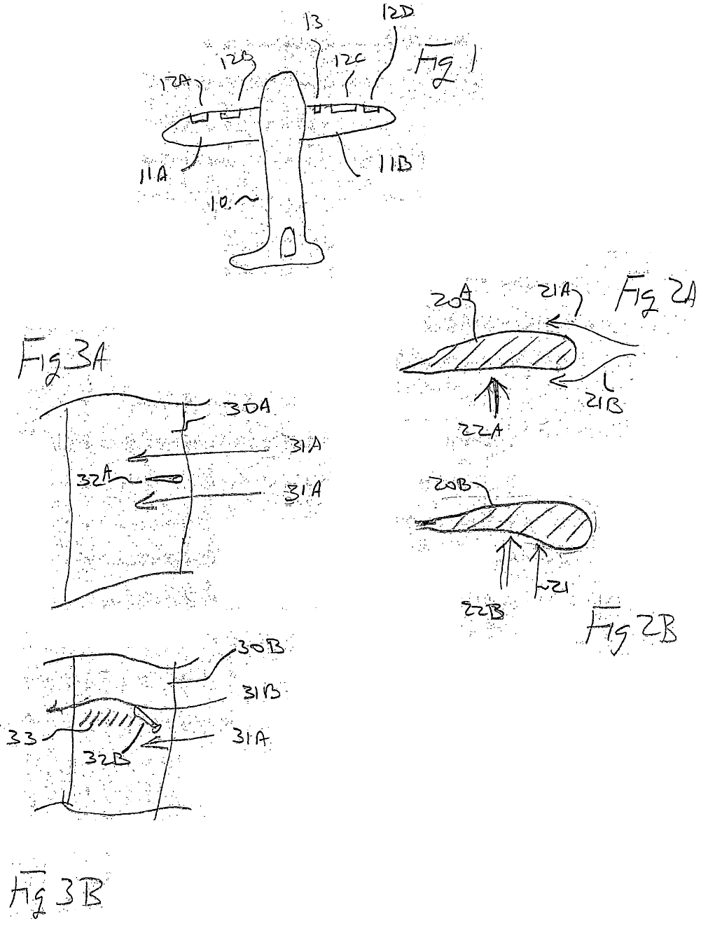

FIG. 1 illustrates an airplane with one embodiment for the placement of the airfoil dampening mechanisms and the motion sensor.

The airplane of this depiction has a fuselage 10 with two airfoils 11A and 11B. In this embodiment, dampening mechanisms 12A, 12B, 12C, and 12D are spread along airfoils 11A and 11B. Motion sensor 13 is mounted within wing 11B and communicates with all of the dampening mechanisms. Note, motion sensor 13 is able to activate dampening mechanisms 13A and 13B on the opposing airfoil 11A.

FIGS. 2A and 2B illustrate the balancing nature of the invention.

Due to the shape of airfoil 20A, as airfoil 20A travels through the air, an upper air flow 21A and a lower air flow 21B is created. The difference in speeds of these two air flows creates the upper lift 22A.

During turbulence, an additional lift 21A is encountered on airfoil 20B, thereby creating excessive lifting forces which cause the “bumpy ride”. The present invention, through the use of the dampening mechanisms reduces the upper lift 22B to compensate/balance for the turbulence lift 21A so as to level out the lifting forces on airfoil 20B.

FIGS. 3A and 3B illustrate the use of a vane for the airfoil dampening mechanism.

Looking at the top of airfoil 30A, as airfoil 30A travels through the air, airflow 31A is created in a smooth manner around vane 32A which acts as the dampening mechanism, now in an inactive state. When the motion sensor (not shown) wants to dampen the lifting of airfoil 30B, vane 32B moves to disrupt the flow of air 31B, creating an area 33 which does not have as much lift as before in FIG. 3A. Air 31A is not affected.

Note, the disrupted air 31B also affects, to a lesser manner, the lift of airfoil 30B in the area where airflow 31B is redirected.

Operation of vane 32A is done via a motor or solenoid located within airfoil 30A.

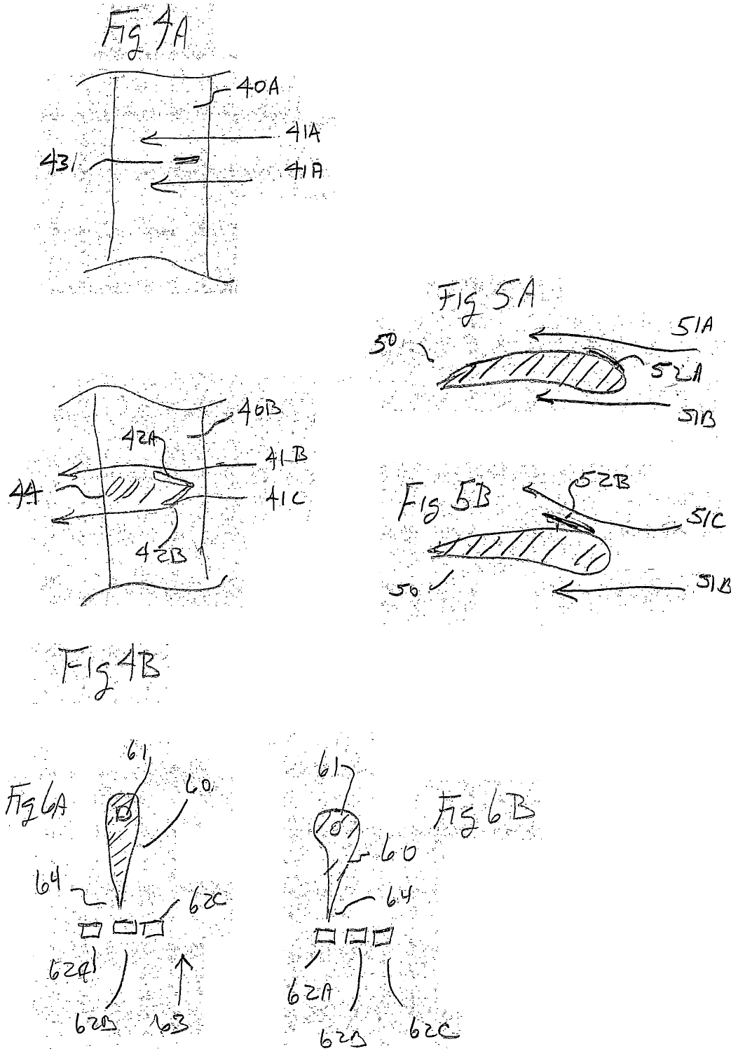

FIGS. 4A and 4B illustrate the use of wings for the airfoil dampening mechanism.

The top-view of airfoil 40B illustrates the uniform flow of air 41A to generate the lifting action on airfoil 40B. Wing mechanism 43A is in its inactive mode.

When turbulence is identified by the motion sensor, not shown, wings 42A and 42B are extended to disrupt the airflow as shown by arrows 41B and 41C. This disruption causes a reduced lifting zone 44 on airfoil 40B so as to compensate for the turbulence.

FIGS. 5A and 5B illustrate the use of a panel for the airfoil dampening mechanism.

As shown in FIG. 5A, the airfoil 50 is in normal flight mode having the airflows 51A and 51B configured to provide lift to airfoil 50. Panel 52A is structured to mimic the leading surface of airfoil 50 and is in an inactive state in FIG. 5A.

When turbulence is sensed, the trailing or rearward portion of panel 52B is raised to disrupt the airflow 51A as shown by arrow 51C. This redirected airflow 51C is incapable of providing the same normal lift which was experienced in FIG. 5A, to compensate for the turbulence.

FIGS. 6A and 6B illustrate the use of a plumb bob arrangement for the motion sensor.

Plumb bob 60 is supported by swivel connection 61 which allows plumb bob to freely rotate thereon and due to gravity and the weighted end 64, points towards the ground. Swivel connection 61 is aligned along the longitudinal axis of the airframe and for purposes of this discussion, this view is from the stern of the aircraft. Plumb bob 60 has a heavy pointed end 64, which in this embodiment, is also magnetized.

Below end 64 is a series of magnetically activated switches 62A, 62B, and 62C which are closed or activated when magnetic end 64 is proximate to an individual switch.

As the starboard airfoil lifts, as indicated by arrow 63, magnetic switches 62A, 62B, and 62C move beneath the plumb bob 61 to that shown in FIG. 6B. When this happens, magnetic switch 64A is closed/activated which is activates the dampening mechanism(s) on the starboard airfoil.

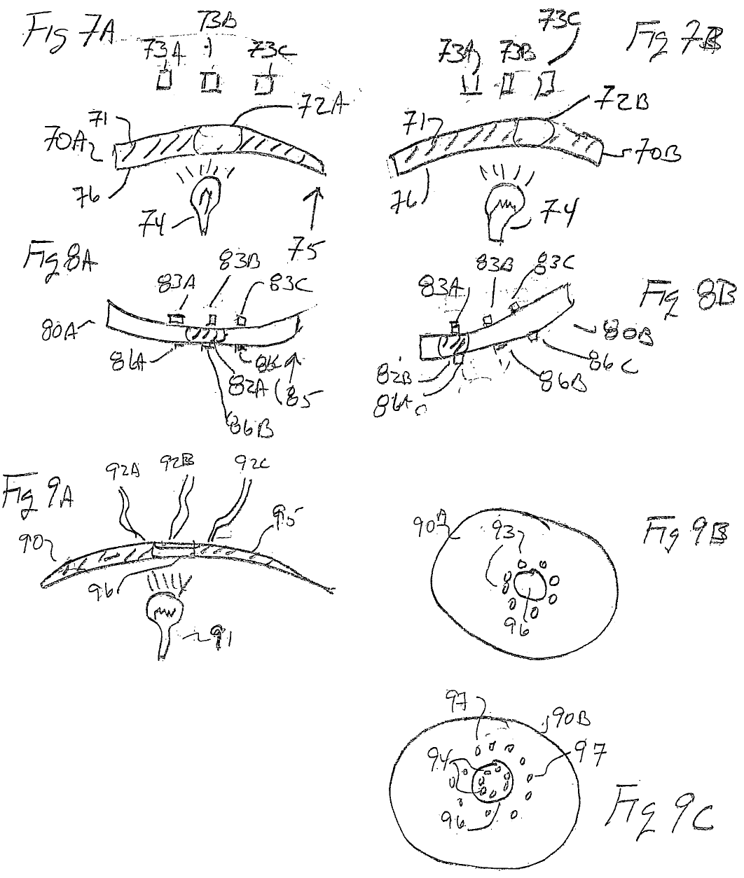

FIGS. 7a and 7B illustrate one embodiment of leveling bubble arrangement for the motion sensor.

In this embodiment, curved tube 76 is filled with an opaque liquid 71 leaving a bubble 72A therein. Bubble 72A may be a gas such as air or can be a clear liquid that doesn't mix with the opaque liquid; and in some situations, a mercury bubble is surrounded by water. Light source 74 shines upward through bubble 72A and impacts, and energizes one of the optical switches 73A, 73B, or 73C.

In FIG. 7A, optical switch 73B is being energized, indicating that no adjustment of the dampening mechanisms (not shown) needs to be done. When turbulence 75 causes the right side of curved tube 76 to move (FIG. 7B), bubble 72B moves and the light source 74 causes optical switch 73C to be energized indicating that the dampening mechanism towards the right should be activated to counter the effects of the turbulence.

FIGS. 8A and 8B illustrate one embodiment of a mercury switch arrangement for the motion sensor.

As with FIGS. 7A and 7B, tubes 80A and 80B is hollow and, in this embodiment, are inverted so that the mercury bubble 82A and 82B move therein making contact with electrodes 83A, 83B, and 83C as well as contacts 86A, 86B, and 86C. Movement, as indicated by arrow 85, indicates turbulence causing the right side (starboard) to rise as indicated in FIG. 8B. In this situation, mercury bubble 82B makes contact with, and electrically connects, electrode 83A and contact 86A indicating that the turbulence has been encountered and that the appropriate dampening mechanism should be activated.

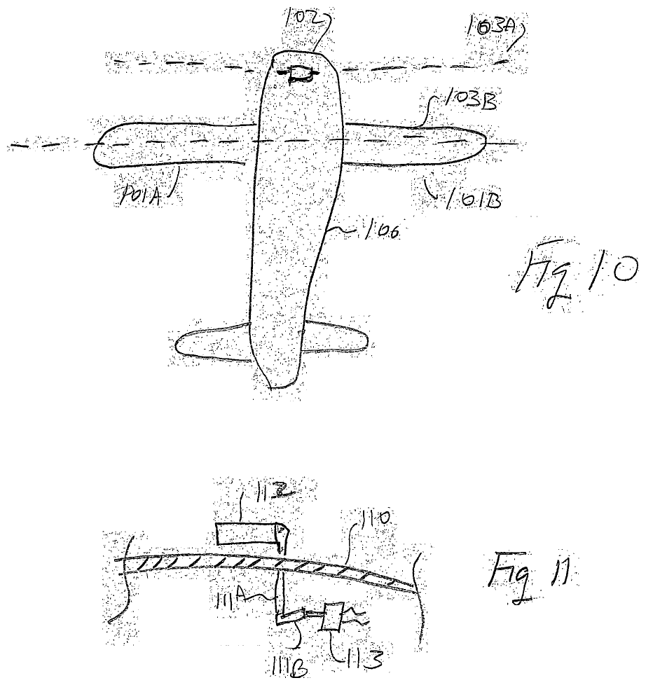

FIGS. 9A, 9B, and 9C illustrate the use of a disc arrangement for the motion sensor.

The motion sensor of this illustration identifies not only left/right motion but also upward/downward and all 360 degrees of motion which may be encountered.

This illustration utilizes the bubble sensor technology described earlier in FIGS. 7A and 7B, that is where the light passes through a clear bubble to be sensed. Other embodiments of this invention utilize the sensors earlier described in FIGS. 8A and 8B, the mercury switch sensing.

In the embodiment of FIGS. 9A, 9B, ad 9C, the hollow container 90 is filled with an opaque liquid 95 with a bubble 96 contained therein and is generally concave (upward) in shape. In another embodiment, the container is concave downward when the mercury switches are used.

In this embodiment, light source 91 shines through bubble 96 which then activates the various fiber optics 92A, 92B, and 92C (only three are shown for simplicity).

As FIG. 9B illustrates, the ends of the fiberoptics 93 in some embodiments are positioned outside of bubble 96. In this situation, a dormant fiberoptic indicates that the bubble has not moved in that direction.

FIG. 9C illustrates the placement of the fiberoptics 93 within the bubble's 96 circle. For this embodiment, when a fiberoptic is activated by the light source, this indicates that that airplane has experienced an elevation in that direction so that proper dampening can occur.

This motion sensor is particularly important when it is desired to disable the motion dampening mechanisms when a significant upward or downward angle is sensed. To get such a limiting angle determination, another ring of fiberoptics 97 encircle the bubble 96 at a wider diameter to make a determination as to the angle being experienced.

FIG. 10 graphically illustrates the orientation consideration for the gyroscope motion sensor in an airplane.

In this embodiment, the motion sensor (gyroscope) 102 is located within the cockpit of the airplane 100. Ideally, this motion sensor is a gyroscope arrangement which is aligned 103A substantially parallel with the alignment 103B of the airfoils 101A and 101B.

FIG. 11 illustrates the motor/solenoid for the dampening mechanisms.

Activating the dampening mechanism is accomplished using solenoid/motor 113 which is secured to an arm 111B of protrusion 11A which extends through the airfoil's skin 110 to move vane 112 (in this illustration) to create the dampening action.

It is clear that the present invention provides for an improved stabilizer for airplanes during rough weather.

What is claimed is:

1. A turbulence dampening system comprising:
a) an aircraft having a fuselage and an airfoil attached thereto;
b) a motion sensor positioned in the aircraft, said motion sensor generating signals indicative of relative motion of the airfoil; and,
c) a first airfoil dampening vane positioned on the airfoil and responsive to signals from the motion sensor to selectively reduce lift of the airfoil, wherein the first airfoil dampening vane re-directs air flowing over the airfoil.

2. (canceled)

3. The turbulence dampening system according to claim 1, further including a second airfoil dampening vane positioned on a second airfoil and responsive to signals from the motion sensor to selectively reduce lift of the second airfoil.

4. The turbulence dampening system according to claim 3, wherein the motion sensor is located within the second airfoil and controls the operation of the dampening vane on the first airfoil.

5. The turbulence dampening system according to claim 3, wherein the motion sensor is located within the fuselage.

6. The turbulence dampening system according to claim 3, wherein the motion sensor is positioned to identify rotational motion of the first and second airfoil around an axis formed by the fuselage.

7. The turbulence dampening system according to claim 6, wherein the motion sensor identifies an upward and downward angle of the fuselage.

8. The turbulence dampening system according to claim 7, wherein the motion sensor suspends operation of the dampening vane when the motion sensor identifies an upward or downward angle exceeding a pre-set value.

9. The turbulence dampening system according to claim 3, wherein the first airfoil dampening vane has a central support protruding through a skin of the first airfoil.

10. The turbulence dampening system according to claim 3, wherein the first airfoil dampening vane has at least one extendable wing.

11. The turbulence dampening system according to claim 3, wherein the first airfoil dampening vane includes:
a) a wind vane extending from the airfoil; and,
b) a solenoid within the first airfoil and connected to the wind vane, said solenoid adapted to selectively rotate the wind vane based on signals from the motion sensor.

12. The turbulence dampening system according to claim 3, wherein the first airfoil dampening mechanism includes:
a) a panel, when inactive, being proximate to an upper surface of the first airfoil; and,
b) a solenoid within the airfoil and connected to the panel, said solenoid adapted to selectively raise a rearward portion of the panel based on signals from the motion sensor.

13. A turbulence dampening system comprising:
a) a motion sensor positioned in an airfoil of an aircraft, said motion sensor generating signals indicative of relative motion of an airfoil; and,
b) an airfoil dampening vane responsive to signals from the motion sensor to selectively reduce lift of the airfoil.

14. The turbulence dampening system according to claim 13, wherein the motion sensor includes a multiple state mercury switch and is aligned along an axis of the airfoil.

15. The turbulence dampening system according to claim 13, wherein the motion sensor includes:
a) a plumb bob having a bottom end; and,
b) a sensor identifying a position of the bottom end of the plumb bob.

16. The turbulence dampening system according to claim 13, wherein the motion sensor includes:
a) a curved clear housing forming a cavity therein;
b) an opaque liquid contained within the housing, said opaque liquid partially filling the cavity of the curved clear housing;
c) a light source focused on a first side of the curved clear housing; and,
d) at least two light receptors positioned on the second side of the curved clear housing, said light receptors being responsive to the light source.

17. The turbulence dampening system according to claim 16, wherein the curved clear housing is tubular in shape.

18. The turbulence dampening system according to claim 16, wherein the curved clear housing is concave in shape.

19. The turbulence dampening system according to claim 13, wherein the motion sensor includes a gyroscope aligned along an axis of the airfoil.
